(19) United States
(12) Patent Application Publication
(10) Pub. No.: US 2005/0195069 A1
(43) Pub. Date: Sep. 8, 2005

(54) Vehicle stopper system

(76) Inventor: Robert Andre Dunand, Brooklyn, NY (US)

Correspondence Address: SCHIFF HARDIN, LLP;PATENT DEPARTMENT, 6600 SEARS TOWER, CHICAGO, IL, 60606-6473, US

(21) Appl. No.: 10/824,951

(22) Filed: Apr. 15, 2004

Related U.S. Application Data
(60) Provisional application No. 60/550,920, filed on Mar. 5, 2004.

(51) Int. Cl. G05B 19/00

(52) U.S. Cl. 340/5.61; 340/5.2; 340/426.11; 340/426.13; 307/10.2

(57) ABSTRACT

A remote control system for reducing the speed of at least one vehicle in an activation radius comprising a remote device for transmitting a wave coded signal and a receiver which is located in all vehicles. The remote device, when properly activated, transmits a wave coded signal to the receivers in all vehicles within a pre-determined radius of the remote device. Once the “Reduce Speed” signal is received, the vehicles are first slowed to a speed of 5-10 mph, and, if the vehicle sought after has not stopped and if it is safe to do so, then if the “Stop” signal is received, the speed of all of the vehicles in the activation radius is further reduced such that the vehicles are stopped or immobilized. In a further improvement of this invention, all vehicles also have a transmitter which identifies the vehicle and enables selective immobilization of vehicles.

### CROSS REFERENCE TO RELATED APPLICATION

This application claims priority of Provisional Application No. 60/550,920, entitled Vehicle Stopper System, filed on Mar. 5, 2004.

### FIELD OF THE INVENTION

The present invention relates to the field of remote control, and more specifically to the remote control of civilian vehicles by law enforcement agencies.

### BACKGROUND OF THE INVENTION

High speed car chases often result in accidents and death. There is a need for law enforcement agency personnel to be able to remotely reduce the speed of and potentially stop the vehicle of a person or persons fleeing the scene of a crime in order to avoid high speed car chases and to assist in the abduction of criminals and law enforcement.

The remote control and/or operation of various functions of motor vehicles is known. For example, U.S. Pat. No. 6,577,227 (Kirchlinde et al.), discloses a remote-controlled access control device including a stationary transceiver device with a triggering device and a portable transponder. This invention is directed to remotely unlocking the door of a vehicle and reducing the risk of an unauthorised unlocking procedure. Additional examples of devices which remotely control the operation of a vehicle follow.

U.S. Pat. No. 5,513,244 (Joao et al.) discloses a remote-controlled anti-theft or theft-deterrent system and method for motor vehicles for disabling a vehicle's ignition system, fuel pump system or auxiliary equipment system once it has been determined that the vehicle's ignition system is shut-off. This invention utilizes a transmitter and receiver system which allows for transmission of remote signals to a receiver over long distances.

U.S. Pat. No. 6,549,117 (Kato et al.) discloses a remote control system for a vehicle capable of controlling, with the use of a single portable transmitter, the door locking/unlocking mechanism and window opening/closing mechanism. This invention provides a remote control system for a vehicle wherein the contents of control are changed depending on the distance between the vehicle and a portable transmitter.

U.S. Pat. No. 6,374,164 (Eklind et al.) discloses a remote control device for remote operation of different functions of a motor vehicle consisting of a portable unit having a housing. In the housing, a plurality of control devices are arranged and are accessible through parts of the housing for manual operation for said control via a transmitter arranged in the housing. The housing of the remote control device of this invention has the shape of the vehicle to be remotely controlled. This device remotely controls the locking and alarming functions of a vehicle.

U.S. Pat. No. 5,754,117 (Inamori et al.) discloses a remote control device for an automotive vehicle wherein a transmitter is received in a holder with side-marker lights and taillights staying on, to connect holder-side contacts to transmitter-side contacts, and the transmitter is removed from the holder to disconnect the transmitter-side contacts from the holder-side contacts. This invention remotely controls vehicle-mounted electrical equipment such as an air conditioner and audio equipment.

U.S. Pat. No. 4,476,954 (Johnson et al.) discloses a remote controller for controlling the throttle, brake and steering mechanism of a conventional motor vehicle. This invention provides control of a motor vehicle with little arm movement and is well suited for use by handicapped individuals. The controller of this invention includes a remote manipulator which controls a plurality of actuators through interfacing electronics.

U.S. Pat. No. 4,345,554 (Hildreth et al.) discloses a remotely controlled engine starter and protective system in which a remotely located radio transmitter is utilized to initiate energization of the starter motor, a first timer opens the starter circuit if the engine does not start in approximately ten seconds, and if the engine starts, a second timer is operative to stop the engine after approximately ten minutes. The objective of this invention is to start and protect the engine of an unattended vehicle through the control of power.

U.S. Pat. No. 4,201,012 (Marshall) discloses a remote control vehicle having four light dependent resistors. Selective light illumination on the light dependent resistors causes the vehicle to be propelled in a forward or reverse direction or to turn in a rightward or leftward direction.

U.S. Pat. No. 6,400,040 (Scudder et al.) discloses a vehicle ignition and remote keyless entry assembly including a key with a remote keyless entry transmitter and a first immobilizer coil and a second immobilizer coil and remote keyless entry antenna insert molded into one of a plurality of ignition assembly components. The objective of this invention is to provide an improved vehicle ignition assembly wherein an immobilizer coil and remote keyless entry antenna are insert molded into existing ignition assembly components for reduced part count and improved robustness of the assembly.

U.S. Pat. No. 6,091,330 (Swan et al.) discloses remotely controlled electrical accessory system for starting an engine of a vehicle and actuating a garage door opener attached to a garage door. This invention allows a driver to start the engine of a vehicle and open a garage door addressing the safety concerns associated with starting a vehicle in a closed garage.

U.S. Pat. No. 6,043,752 (Hisada et al.) discloses a remote-control unit for vehicles in which an immobilizer facility and keyless entry facility are united to enable bidirectional transmission. This antitheft device is directed to controlling engine start as well as the door lock of the vehicle.

U.S. Pat. No. 5,751,072 (Hwang) discloses a vehicle security system which by entering a programmable security code can perform an emergency system disarm when the remote control transmitter is lost. This invention also allows the user to teach a new transmitter code in the event the remote control transmitter is lost or broken.

U.S. Pat. No. 5,729,192 (Badger), discloses a device and method for remotely disabling an automobile by transmitting a signal which is received by a receiver of a single vehicle. The receiver of the Badger patent is controllably connected to a circuit which is able to interfere with the connection of the operating voltage to the ignition components of the automobile. The Badger patent focuses on electricity principles rather than electronics, whereas today most cars have electronic circuits to control the electrical functions.

It is desirable to provide a device and system for remotely controlling a plurality of vehicles within a particular radius with the transmission of a single signal. It is further desirable to provide a remote control device and system for remotely controlling vehicles within a particular radius for use by law enforcement agencies. It is also desirable to provide a device and system for remotely reducing the speed of vehicles within a particular radius in which the speed of the vehicles is first reduced so that the vehicles are slowed down and then reduced further until the vehicles are stopped or immobilized.

### SUMMARY OF THE INVENTION

The present invention provides a remote control device and system for remotely reducing the speed of at least one vehicle within an activation radius comprising a remote device for use by a law enforcement agent and a receiver which is located in all vehicles. The remote device, when activated by a law enforcement agent, sends a wave coded signal to the receivers in all vehicles within a pre-determined radius of the remote device. Once the “Reduce Speed” signal is received, the speed of the vehicles is first reduced to a speed of about 5-10 mph, and, if the vehicle sought after has not stopped and if it is safe to do so, then if the “Stop” signal is received, the speed of all of the vehicles is further reduced such that the vehicles are stopped or immobilized.

It is an object of the invention to provide a remote control device and system for remotely reducing the speed of at least one vehicle with the transmission of a single signal.

It is an object of the invention to provide a remote control device and system for remotely reducing the speed of all vehicles within a pre-determined radius.

It is an object of the invention to provide a remote control device and system for remotely reducing the speed of at least one vehicle within an activation radius, first reducing the speed of the vehicle and then reducing the speed of the vehicle such that it is stopped or immobilized.

It is also an object of the invention to provide a remote control device and system for use by law enforcement agencies to avoid accidents and deaths when police (or other law enforcement personnel) try to stop a vehicle.

It is an object of the invention to provide a remote control device and system for increasing the efficiency of law enforcement organizations.

It is another object of the invention to provide a remote control device and system for reducing the number of stolen vehicles.

It is a further object of the invention to provide a remote control device and system for reducing the speed of vehicles which is secure and user friendly.

It is another object of the invention to provide a remote control device and system for assisting law enforcement agencies with strict enforcement of the laws and regulations.

Further objects of the invention include, among others, to reduce the risk of terrorist activities using a vehicle, to recover unpaid taxes and fines and to arrest people who are wanted by law enforcement agencies.

These and other objects, features and advantages of the present invention will become more apparent from the following detailed description of the present invention and accompanying drawings and claims.

### BRIEF DESCRIPTION OF THE DRAWINGS

FIG. 1 is a diagram of one preferred embodiment of the invention.

FIG. 2 is a diagram of another embodiment of the invention.

FIG. 3 is a drawing of one embodiment of the Remote Vehicle Stopper of this invention.

FIG. 4 is a diagram of another embodiment of the invention.

FIG. 5 is a diagram of another embodiment of the invention.

### DETAILED DESCRIPTION OF THE INVENTION

The following is a description of one preferred embodiment as well as certain alternative embodiments of the present invention. Further embodiments will become apparent to those skilled in the art. The following description is merely illustrative of the present invention and is not to be construed as limiting the scope of the present invention.

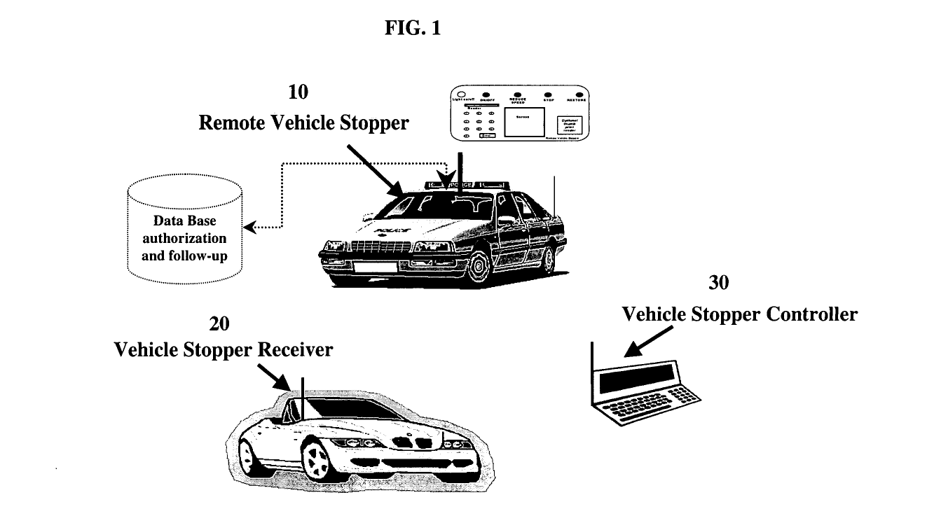

Referring to FIG. 1, the preferred embodiment of the present invention is comprised of the following devices: (1) the Remote Vehicle Stopper (RVS) 10 in the law enforcement agency vehicle, (2) the Vehicle Stopper Receiver (VSR) 20 in all vehicles and (3) a Vehicle Stopper Controller (VSC) 30.

In the preferred embodiment, the Remote Vehicle Stopper 10 is a device located in a law enforcement agency vehicle (for example, a police car, truck or bus, but it could also be a motorbike, bike, boat or helicopter) and operated by an identified law enforcement agent (for example, a police officer or other law enforcement agent). The Remote Vehicle Stopper device 10 is a secured device in the preferred embodiment. Means of securing the Remote Vehicle Stopper 10 include, but are not limited to, for example, the following: smart card, password, biometric reader, electronic key, magnetic strip card and access card.

The Remote Vehicle Stopper 10, when operated by the authorized law enforcement agent, will reduce the speed of any “civilian” vehicle within the activation radius by sending a wave coded signal to a receiver (Vehicle Stopper Receiver 20) located in all vehicles (car, van, truck, bus, motorbike or boat).

Traceability is an important feature of this invention. The public and the law enforcement agencies would like to make sure that a powerful tool like the Vehicle Stopper System is operated properly and according to the law and regulations. To achieve these objectives, law enforcement agencies will have a procedure for authorizing use of the present invention such that use of the Vehicle Stopper System will be secured and recorded and the law enforcement agents using the system will be identified. All of these functions will provide a high level of traceability and security.

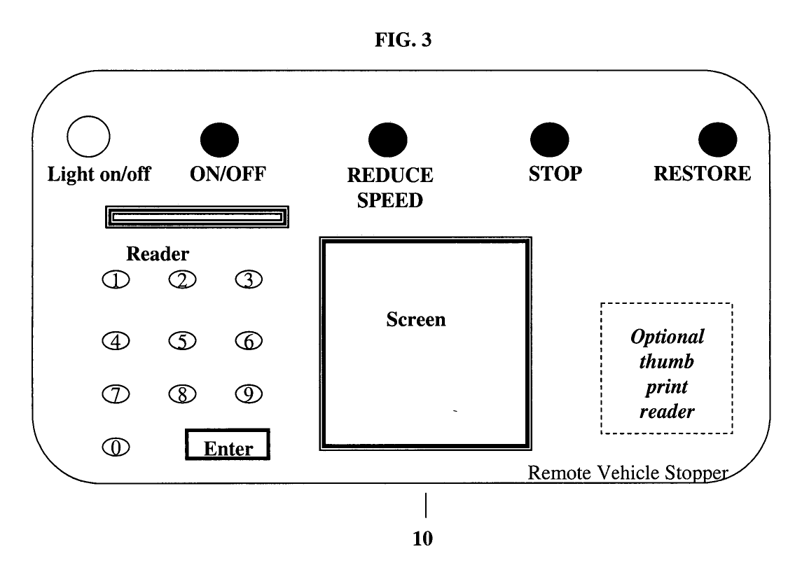

The Remote Vehicle Stopper 10 has a plurality of buttons for selecting various functions, for example, “Reduce Speed,” “Stop,” “Restore,” etc. and may be shaped, for example, like a car radio with a LCD screen to guide the law enforcement agent as shown in FIG. 3. The Remote Vehicle Stopper device 10 is linked to the computer and database of the chain of command of the law enforcement agency.

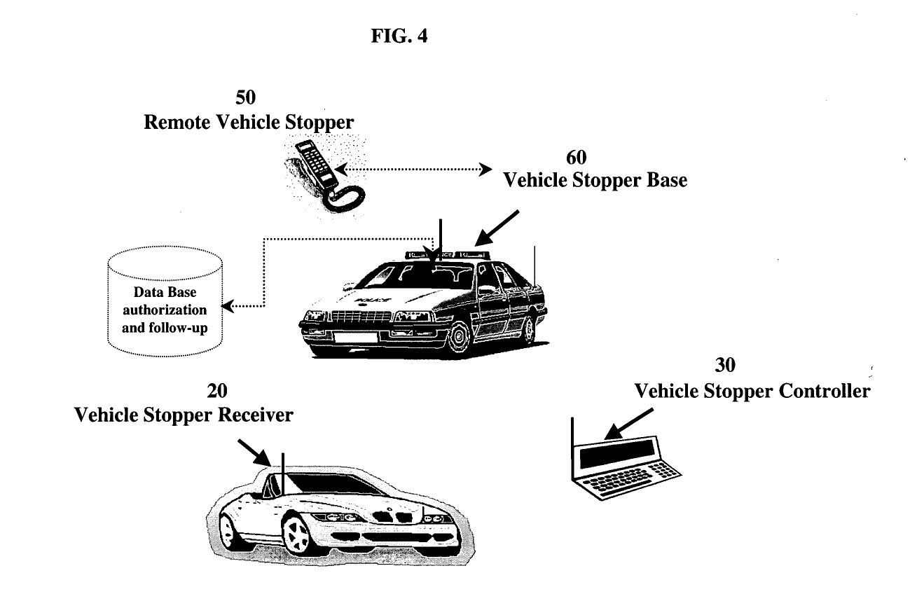

In another embodiment, the Remote Vehicle Stopper is a hand held device 50 and is linked to another device located in the law enforcement agency vehicle, the Vehicle Stopper Base 60, as shown in FIG. 4. The link between these two devices is secured mechanically, electronically and electrically.

The Vehicle Stopper Receiver (VSR) 20 is the receiver located in the “civilian” vehicle. To operate effectively, a receiver 20 should be located in all “civilian” vehicles, which receiver is similar to the antitheft devices used to protect vehicles from being stolen. The receiver 20 should also be tamperproof like the antitheft devices. Police vehicles, Fire Department vehicles, ambulances and other equivalent vehicles (including armored cars) will have a Vehicle Stopper Receiver 20 but it will be deactivated while on duty so that such vehicles will not be stopped by the present invention.

When the Vehicle Stopper Receiver 20 receives the proper wave coded signal, i.e. if the police officer (or other law enforcement agent) has pushed a first button (i.e. “Reduce Speed” button) on the Remote Vehicle Stopper 10, the fuel supply is reduced so that the speed of all of the civilian vehicles in the activation radius is reduced to about 5 to 10 miles per hour. In another embodiment, the civilian vehicles' warning lights will blink slowly in response to the “Reduce Speed” wave coded signal.

If the police officer (or other law enforcement agent) presses a second button (“Stop” button) on the Remote Vehicle Stopper 10, the system cuts the fuel supply or ignition of all civilian vehicles within the activation radius and the speed of the vehicles is reduced such that the vehicles are stopped or immobilized. Additionally in another embodiment, the civilian vehicles' warning lights will blink quickly in response to the “Stop” wave coded signal.

In the preferred embodiment, the Remote Vehicle Stopper 10 will not stop all vehicles in the activation radius abruptly, although capable of doing so. It will reduce the fuel supply first so that all maneuvering capabilities of the vehicles are not lost. The fuel supply is reduced so that the speed of the vehicles is reduced to a maximum speed of about 5 to 10 mph. If the law enforcement agent chooses to press the “Stop” button of the Remote Vehicle Stopper 10, then the ignition or fuel supply of the vehicles in the activation radius will be cut. This is based on the assumption that all modern vehicles have an electronically controlled fuel injection system. For vehicles not having electronic fuel injection systems, it will not be possible to reduce the fuel supply. Accordingly, only the “Stop” button will be effective.

The law enforcement agent can give back the fuel supply and ignition control to the civilian vehicles if he or she chooses to do so by pressing a third button on the Remote Vehicle Stopper (“Restore” button) 10. When activated, used and deactivated, the Remote Vehicle Stopper device 10 will send a signal to the law enforcement agency headquarters to report the situation.

The Remote Vehicle Stopper 10 will also have the ability to activate the warning lights of the vehicles within the activation radius to test vehicles on the road or at a toll booth, for example.

The activation radius of the present invention may be varied enabling the control of either a wide range of vehicles or a much more limited number of vehicles, including a single vehicle. For example, the activation radius may be about 100 to 300 feet, providing for the control of potentially numerous vehicles. Alternatively, the activation radius may be reduced to about 3 to 10 feet, providing for the control of a single vehicle. The activation radius may be varied, for example, by increasing or decreasing the strength of the transmission of the wave coded signal. In alternative embodiments, the activation radius may be limited using such means as metal shields, for example, using a Faraday Cage or similar device to create a controlling station managed by the Vehicle Stopper Controller 30.

The wave coded signal is a secured digital radio signal in a dedicated bandwidth. This signal may be secured using, for example, an adaptation of the Wireless Transport Layer Security Protocol.

The Vehicle Stopper Controller 30 is a computer station with a receiver and a transmitter which controls, manages, and updates the Remote Vehicle Stopper 10 and the Vehicle Stopper Receiver 20 (and the Vehicle Stopper Base 60 in the embodiment where such device is used). The Vehicle Stopper Controller 30 is also a secured device in the preferred embodiment. Means of securing the Vehicle Stopper Controller 30 include, but are not limited to, for example, the following: smart card, password, biometric reader, electronic key, magnetic strip card and access card. The Vehicle Stopper Controller 30 sends data to a computer network that is part of the chain of command of the law enforcement agency. This network and these computers will be securely connected and protected.

If a GPS is in the law enforcement agency vehicle, the localization data will also be sent to the law enforcement agency headquarters. If the law enforcement agency vehicle is out of range of the headquarters, it will store data for uploading to a computer system, the Vehicle Stopper Controller (VSC) 30, at a later time. This feature will add another element of traceability as the one described above.

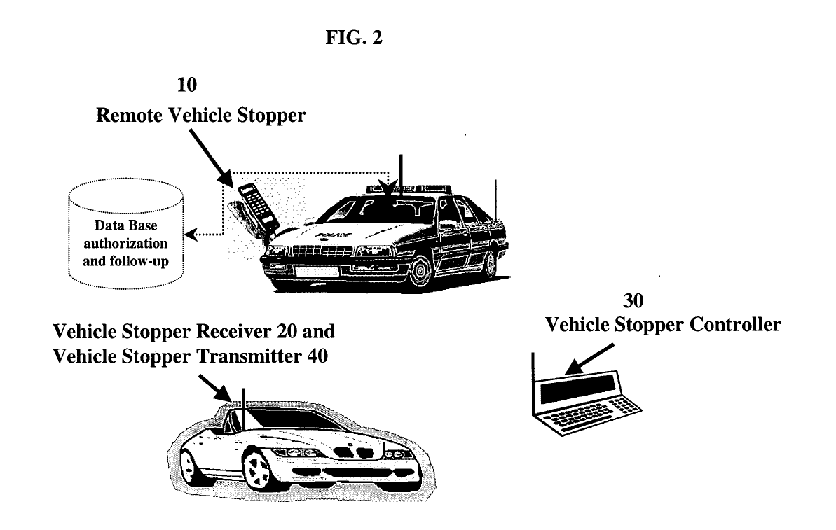

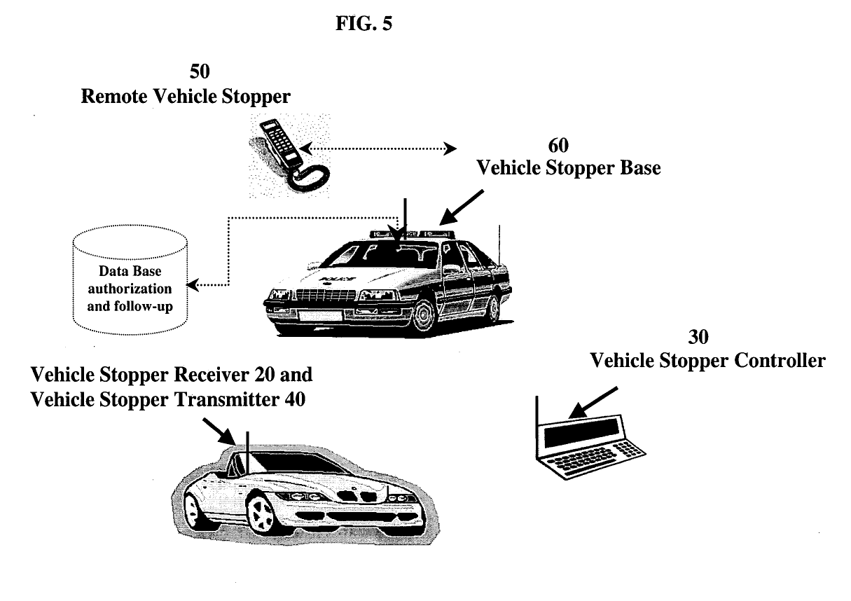

Referring now to FIGS. 2 and 5, another embodiment of the invention includes a Vehicle Stopper Transmitter (VST) 40, which is located in all vehicles. In one embodiment, for example, the Vehicle Stopper Transmitter 40 may be located next to the Vehicle Stopper Receiver 20. The Vehicle Stopper Transmitter 40 sends various types of data, for example, vehicle identification data (such as the vehicle identification number and registered license plate number) and status data, back to the Remote Vehicle Stopper 10 and the Vehicle Stopper Controller 30 so that the law enforcement agent can, for example, compare it to what he sees on the vehicle license plate.

All components of the system of the invention should be tested regularly. In particular, the Vehicle Stopper Receiver 20 should be checked regularly to make sure it works as expected and that it has not been deactivated. The testing should be done around some well selected places such as toll booths, banks which have been repeatedly robbed, embassies, customs, etc. The Vehicle Stopper Receiver 20 will answer by sending a particular signal (the system will be in testing mode and will not stop the vehicle). The system should be tested completely during inspection of the vehicle to confirm that the vehicle slows down and stops as it should when so activated by the law enforcement agent.

A checking station equipped with a Vehicle Stopper Controller 30 will automatically check to verify that each vehicle tested responds as expected, and in embodiments including a Vehicle Stopper Transmitter 40, will also confirm that the vehicle tested is not one of a list of vehicles to be apprehended. In order to test only a single vehicle, either the activation radius will be reduced or the use of a metal shield such as a Faraday Cage may be employed. Other means of reducing the activation radius may also be employed. The Vehicle Stopper Controller 30 transmits a signal to the Vehicle Stopper Receiver 20 of the vehicle to confirm that it responds as expected. In the embodiment including a Vehicle Stopper Transmitter 40, the Vehicle Stopper Controller 30 transmits a signal to the vehicle requesting vehicle identifying data, for example, the vehicle identification number. The Vehicle Stopper Transmitter 40 transmits the requested data back to the Vehicle Stopper Controller 30. The Vehicle Stopper Controller 30 determines whether this vehicle is on the list of vehicles to be apprehended.

If the Vehicle Stopper Receiver 20 of the vehicle does not work properly, or if the vehicle is sought after or on the list of vehicles to be apprehended, the tested vehicle will be stopped either automatically by the Vehicle Stopper Controller 30 sending a signal to the Vehicle Stopper Receiver 20, or the driver of the vehicle will be asked to stop and a picture of the vehicle and license plate will be taken. If the driver of the vehicle does not stop the vehicle, the vehicle should be stopped by traditional means. A law enforcement agent may also activate the Remote Vehicle Stopper 10 to transmit a wave coded signal to all vehicles in a wider radius in this scenario, thereby reducing the speed of at least the traffic around the fleeing vehicle. The Vehicle Stopper Controller 30 may be operated automatically or by a law enforcement agent.

This invention may be used to block vehicles efficiently when their owners have not paid taxes, parking tickets, etc. or because they should be arrested. It will avoid the use of the “Denver boot” or other vehicle immobilization device.

A law enforcement agent may also determine whether a vehicle is sought after or on a list of vehicles to be apprehended by activating the Remote Vehicle Stopper 10, sending a signal to the Vehicle Stopper Transmitters 40 of the vehicles within the activation radius requesting vehicle identification data. The Vehicle Stopper Transmitters 40 of the vehicles in the activation radius will send their vehicle identification data back to the Remote Vehicle Stopper 10, at which time the law enforcement agent may determine whether any one of the vehicles within the radius should be stopped. The law enforcement may then elect to reduce the speed of all of the vehicles within the activation radius.

In another embodiment of the invention, if it is determined at a checking station, for example, that a vehicle is sought after or that a law enforcement agency desires to stop a particular vehicle, the vehicle may be stopped at a pre-determined time including, for example, the next time the vehicle is started, after the vehicle is started a certain number of times (i.e. the fifth time the vehicle is started) or after a certain number of miles (i.e. after 50 miles). In this embodiment, only a single vehicle is controlled by either varying the activation radius or through the use of a device such as metal shield or a Faraday cage.

In addition to testing that the speed of vehicles can be reduced, the Vehicle Stopper Controller 30 and Vehicle Stopper Transmitter 40 should be regularly tested to check that the Vehicle Stopper Controller 30 is receiving valid vehicle identification data such as the vehicle identification number from the Vehicle Stopper Transmitter 40. When circumstances allow, for example, during vehicle inspection, a real comparison will be done between the vehicle identification number and/or the license plate number visible on the screen of the Vehicle Stopper Controller 30 and the actual vehicle identification number on the engine and/or the license plate number on the vehicle.

To avoid jamming, the civilian vehicle will be stopped if a jamming device is detected (all frequencies of the range with a powerful signal). Otherwise, it could be possible for a professional robber to put a very primitive jammer (emitter working on all the range of frequencies concerned and powered by a battery) in the vehicle he or she wants to steal or avoid to be stopped by the law enforcement agents. The signal sent by the jammer will mask the signal sent by the law enforcement agent and the Remote Vehicle Stopper 10 will not operate. So to circumvent this flaw, the Vehicle Stopper Receiver 20 reduces the fuel supply if a powerful signal is detected which looks like a jamming signal. For vehicles without fuel injection, the jamming will stop the ignition. In this case, if there is a dangerous environment, like a railroad, for example, a special button on the civilian vehicle will allow for a few seconds to delay the stopping process. This feature will assist a driver in exiting a dangerous area (for example, railroad, freeway, etc.) or an area where there is a lot of industrial noise (for example, manufacturing plant, arc welding station, etc.) by delaying the effect of the anti-jamming process for a few seconds.

In case of industrial noise (electronic emission of radio waves), which may have the effect of jamming, the Vehicle Stopper Receiver 20 will reduce the fuel supply of the vehicle and it will still be possible to drive the vehicle at a reduced speed until the vehicle is outside of this difficult electromagnetic environment. For vehicles without fuel injection, the industrial noise will stop the ignition. In this case, if there is a dangerous environment a special button may be used as described above.

Another use of this invention may be to automatically reduce the speed of all vehicles under specific circumstances, for example, near a school or a school bus, a road block, in case of emergencies, etc.

It will be clear that the present invention is well adapted to carry out the objects and attain the ends and advantages mentioned as well as those inherent therein. While certain embodiments have been described for purposes of this disclosure, numerous changes may be made which will readily suggest themselves to those skilled in the art and which are encompassed in the spirit of the invention disclosed.

1. A remote control system for controlling at least one vehicle within an activation radius comprising:
a remote device for transmitting a wave coded signal to at least one vehicle within an activation radius; and
a receiver which is located in at least one vehicle within the activation radius for receiving the wave coded signal;
wherein receipt of the wave coded signal by said receivers in said vehicles causes the speed of the vehicles to be reduced in response to the wave coded signal.

2. The remote control system of claim 1, wherein said remote device is located in a law enforcement agency vehicle.

3. The remote control system of claim 2, wherein said law enforcement agency vehicle is selected from the group consisting of motor vehicle, motorbike, bike, boat and helicopter.

4. The remote control system of claim 1, wherein said receiver is located in all vehicles.

5. The remote control system of claim 1, wherein said vehicle is selected from the group consisting of car, van, truck, bus, motorbike and boat.

6. The remote control system of claim 1, wherein the activation radius is about 100 to 300 feet from the remote device.

7. The remote control system of claim 1, wherein the activation radius is about 3 to 10 feet from the remote device.

8. The remote control system of claim 1, wherein said remote device is linked to a computer of a law enforcement agency.

9. The remote control system of claim 1, wherein said remote device consists of a hand held remote unit and a base unit which is physically located in a law enforcement agency vehicle, wherein said hand held remote unit and said base unit are linked together.

10. The remote control system of claim 1, wherein the speed of the vehicles is reduced to about 5-10 mph in response to the wave coded signal.

11. The remote control system of claim 1, wherein the speed of the vehicles is reduced such that the vehicles are stopped in response to the wave coded signal.

12. The remote control system of claim 1, wherein the speed of the vehicles is first reduced to about 5-10 mph in response to a first wave coded signal and second the speed of the vehicles is further reduced such that the vehicles are stopped in response to a second wave coded signal.

13. The remote control system of claim 1, wherein the speed of the vehicles is reduced by controlling the fuel supply of the vehicles in response to the wave coded signal.

14. The remote control system of claim 1, wherein the speed of the vehicles is reduced by cutting the ignition of the vehicles in response to the wave coded signal.

15. The remote control system of claim 1, wherein receipt of the wave coded signal by said receivers in said vehicles causes the warning lights of said vehicles to blink in response to the wave coded signal.

16. The remote control system of claim 15, wherein the warning lights of said vehicles blink slowly or quickly.

17. The remote control system of claim 1, wherein the control of the speed of the vehicles is returned to the operator of the vehicle in response to the wave coded signal.

18. The remote control system of claim 1, wherein the remote device is secured.

19. The remote control system of claim 1, wherein the remote device is secured by a means selected from the group consisting of smart card, password, biometric reader, electronic key, magnetic strip card and access card.

20. The remote control system of claim 1, wherein said wave coded signal is a secured digital radio signal in a dedicated bandwidth.

21. The remote control system of claim 1, wherein said remote device has at least one push button.

22. The remote control system of claim 1, further comprising a controller for controlling said remote device and said receiver.

23. The remote control system of claim 22, wherein said controller is a computer station with a receiver and a transmitter.

24. The remote control system of claim 22, wherein the controller is secured.

25. The remote control system of claim 22, wherein the controller is secured by a means selected from the group consisting of smart card, password, biometric reader, electronic key, magnetic strip card and access card.

26. The remote control system of claim 1, further comprising a transmitter which is located in at least one vehicle for transmitting data.

27. A method for remotely controlling at least one vehicle within an activation radius comprising the steps of:
transmitting a wave coded signal to be received by the receiver in at least one vehicle in the activation radius;
receiving the wave coded signal by the receiver of said vehicles; and
reducing the speed of said vehicles in response to the wave coded signal.

28. The method of claim 27, further comprising the step of disarming the remote device.

29. The method of claim 27, wherein the step of reducing the speed of said vehicles includes reducing the speed of the vehicles to about 5-10 mph in response to a wave coded signal.

30. The method of claim 27, wherein the step of reducing the speed of said vehicles includes reducing the speed of the vehicles such that the vehicles are stopped in response to a wave coded signal.

31. The method of claim 27, wherein the step of reducing the speed of said vehicles includes first reducing the speed of said vehicles to about 5-10 mph in response to a wave coded signal and second reducing the speed of the vehicles such that the vehicles are stopped in response to a second wave coded signal.

32. The method of claim 27, wherein the step of reducing the speed of said vehicles includes causing the warning lights of the vehicles to blink in response to the wave coded signal.

33. The method of claim 27, further comprising the step of transmitting data from a transmitter located in a vehicle.

34. A remote control device enabling the control of at least one vehicle within an activation radius comprising:
a remote device configured and adapted for transmitting a wave coded signal to at least one vehicle within an activation radius;
wherein receipt of the wave coded signal by the receiver in said vehicles within the activation radius causes the speed of said vehicles to be reduced.
